(19) United States
(12) Patent Application Publication
(10) Pub. No.: US 2025/0360745 A1
(43) Pub. Date: Nov. 27, 2025

(54) GREETING CARD WITH A REMOVABLE KINETIC MOBILE STRUCTURE, WITH METHOD OF USE METHOD OF MANUFACTURE

(71) Applicant: Aaron Stanley, Dover, NH (US)

(72) Inventor: Aaron Stanley, Dover, NH (US)

(21) Appl. No.: 18/673,329

(22) Filed: May 24, 2024

(51) Int. Cl. B42D 15/04

(52) U.S. Cl. CPC B42D 15/045

(57) ABSTRACT

A greeting card with a removable kinetic mobile sculpture is disclosed. The greeting card can include a holding board and a flap. The holding board can have pockets that can house one or more structures of the sculpture that can be movably attached to one or more other structures. The sculpture can be preassembled and stored in the holding board, and can be lifted out of the holding board in one motion for immediate deployment of the complete and preassembled mobile sculpture. A flap can cover the holding board in a closed position, such that, in the closed position, the one or more structures are securely placed and hidden in the pockets of the holding board.

### BACKGROUND

### Technical Field

This invention generally relates to greeting cards, and more particularly to greeting cards with removable features.

### Description of the Related Art

Greeting cards, small pieces of sentimentality, have remained a cherished tradition for decades. These folded pieces of sheet hold the power to convey emotions, celebrate milestones, and connect people across distances. Whether adorned with heartfelt messages, whimsical illustrations, or beautiful photographs, greeting cards offer a tangible and enduring way to express love, sympathy, joy, and gratitude. From birthdays to weddings, holidays to sympathy, they serve as tokens of affection, spreading warmth and creating lasting memories. The greeting card structure has at least one panel, and preferably a plurality of panels which, when opened, reveal either sequential parts of the message, or the entire message. The panels are generally formed of a sheet stock that is stiff enough to self-support a two-panel greeting card when placed, on edge, on a horizontal support surface, such as a desk, shelf, or mantel, in a partially open position.

Typically, high-quality greeting cards can be expensive, especially when factoring in the price of the card itself, postage, and any additional gifts or decorations. Further, the traditional greeting cards often lead to unnecessary clutter and storage challenges over time since people often find it hard to part with sentimental cards. In order to overcome such challenges, people often opt for digital greeting cards but they cannot replace the traditional greeting cards at least for the reason that in a world dominated by digital communication, the physical presence of the greeting card evokes a special sense of connection and thoughtfulness, reminding us of the enduring power of handwritten sentiments. Therefore, the traditional greetings are usually preferred over the digital greeting cards. However, despite being costly and having high sentiment value, they end up being discarded after a short span of time and contribute to waste and landfill issues.

There have been attempts to enhance the interactivity of greeting cards, such as pop-up cards or musical cards, however, such cards still do not fully address the desire for a unique and memorable gifting experience. Some kinetic cards exist but at best, they display a self-contained mobile. The self-contained mobile is conventionally one-piece and cannot be removed and deployed.

There is a need for improved greeting cards that can be stored or utilized by a receiver efficiently to overcome the abovementioned drawbacks. There exists a need for an improved greeting card, such as a greeting card that improves interactivity and engagement beyond a simple reading or viewing experience. Furthermore, there is a need for an improved greeting card that transforms the traditional concept of greeting cards into a dynamic and interactive form of expression.

### BRIEF SUMMARY

This disclosure overcomes disadvantages of the prior art by providing an improved greeting card. The greeting card disclosed herein can include a preassembled and removable mobile or sculpture, and the greeting card can include pockets for securely placing the self-contained and easily deployable mobile, which can improve interactivity with the greeting card. The improved greeting card can include sculptures or items that are reusable and can be removed from the greeting card and used by people. The greeting card can incorporate a preassembled and deployable sculpture which can be easily accessed, deployed, and put back into the card, creating a memorable and enduring experience for the recipient.

Various embodiments are directed to a greeting card with a removable kinetic mobile structure. In an embodiment, the greeting card can include a holding board and a flap. The holding board and the flap can be made of a rigid material selected from, by way of non-limiting example, wood veneer, metal, alloy, plastic, cardboard, or a combination thereof. The holding board can have pockets to house one or more structures movably attached via one or more attachment means. The one or more structures can be made of a rigid material selected from, by way of non-limiting example, wood veneer, metal, alloy, plastic, cardboard, or a combination thereof. Further, the one or more attachment means can include, by way of non-limiting example, jump ring, string, spring, or a combination thereof.

In an embodiment, the holding board can include a core insert that is laser cut to form the pockets to house each of the one or more structures in fixed locations. The core insert can be made of a material selected from foam, wood veneer, cardboard, and/or corrugated board. In various embodiments, the fixed location for housing each of the one or more structures can be selected in a way that the one or more structures do not tangle with each other. In various embodiments, the fixed location for housing each of the one or more structures can be selected in a way that the one or more structures are placed aesthetically to look beautiful when the flap is removed. Further, the holding board can house one or more strings attached to the one or more structures such that, upon removing from the holding board, the one or more structures can hang from the one or more strings to represent a removable 3-dimensional kinetic mobile sculpture. Accordingly, the removable 3-dimensional kinetic mobile sculpture is pre-assembled from a plurality of structures, and a user holds the one or more strings to remove the one or more structures of the sculpture for immediate deployment.

In an embodiment, the removable 3-dimensional kinetic mobile can correspond to a hangable decorative, an earring, a spiral lampshade design, or a combination thereof. In the case of the hangable decorative, the one or more strings of the removable 3-Dimensional kinetic mobile can be attached to a first coupling means to removably attach to a ceiling. In the case of the earring, the one or more strings of the removable 3-Dimensional kinetic mobile can be attached to a second coupling means to removably attach to an ear. The second coupling means can include, by way of non-limiting example, earring hook, earring post, earring stud, earring back and clutch, earring hoop, lever back, threader, fingernail, and/or clip. In the case of the spiral lampshade design, at least one of the one or more structures can be a conical helix, such that, upon removal from the holding board, the removable 3-dimensional kinetic mobile forms a cone, and at least one of the one or more structures can be aesthetically arranged around an outer surface of the cone.

In an embodiment, a greeting card can include a kinetic mobile sculpture. The kinetic mobile sculpture can include a plurality of structures movably attached together via one or more connectors, and a suspender attached to one of the plurality of structures such that, upon removing from the holding board, the plurality of structures hang from the suspender to represent a removable 3-dimensional kinetic mobile. The greeting card can include a holding board having a plurality of pockets corresponding to the plurality of structures and adapted to hold the structures within the pockets.

The greeting card can include a flap for covering the holding board in a closed position, such that, in the closed position, the one or more structures are securely placed and hidden in the pockets of the holding board. The holding board can be laser cut to house each of the one or more structures in fixed locations. The fixed location for housing each of the plurality of structures can be selected in a way that the one or more structures do not tangle with each other as the structures are removed from the holding board. The fixed location for housing each of the plurality of structures can be selected in a way that the plurality of structures are placed aesthetically to look beautiful when the flap is removed. The holding board can be made of a material selected from at least one of: foam, wood veneer, cardboard, and corrugated board. The one or more structures can be made of a rigid material selected from at least one of: wood veneer, metal, alloy, plastic, and cardboard. The kinetic mobile sculpture can be a hangable decorative, and the suspender can be attached to a first coupler so that the kinetic mobile sculpture can be removably attached to a ceiling by the suspender. The kinetic mobile sculpture can be an earring, and the kinetic mobile sculpture stored within the holding board can include a hook adapted to removably attaching the kinetic mobile sculpture to an ear. The kinetic mobile sculpture can include a three-dimensional backdrop, wherein the three dimensional backdrop can be stored in a flat conformation within the holding board and can be adapted to be deployed automatically into a three-dimensional conformation when the three-dimensional backdrop is removed from the holding board, without further assembly by the user. At least one of the plurality of structures can be aesthetically arranged around an outer surface of the three-dimensional backdrop. The holding board can be made of a rigid material selected from at least one of: wood veneer, metal, alloy, plastic, and cardboard. The one or more connectors can include at least one of: jump ring, string, and spring. The removable 3-dimensional kinetic mobile sculpture is pre-assembled while packaged in the holding board, and the 3-dimensional kinetic mobile sculpture is adapted for a user to lift the suspender to remove the kinetic mobile sculpture for immediate deployment.

In various embodiments, a greeting card can include a front flap, a back section, and a holding board secured to the back flap. The holding board can have a plurality of pockets, the pockets adapted to correspond to a plurality of structures of a kinetic mobile sculpture and adapted to hold the structures within the pockets. The front flap can be pivotably connected to the back section, and the front flap can be pivoted between an open position and a closed position, and in the closed position the front flap can lay over the holding board and cover the pockets. The one or more connectors can include at least one of: jump ring, string, and spring.

A method of deploying a preassembled kinetic mobile sculpture can include opening a front flap of the greeting card to reveal a holding board, the holding board having a plurality of pockets adapted to correspond to a plurality of structures of a pre-assembled kinetic mobile sculpture, and wherein the plurality of structures of the preassembled kinetic mobile sculpture are housed within the pockets of the holding board. The method can include grasping a string attached to one of the plurality of structures of the preassembled kinetic mobile sculpture, lifting the preassembled kinetic mobile sculpture out of the holding board of the greeting card, and displaying the preassembled kinetic mobile sculpture without the need for assembly of the kinetic mobile sculpture. Lifting the preassembled kinetic mobile sculpture out of the holding board of the greeting card can include lifting the preassembled kinetic mobile sculpture out of the holding board of the greeting card in a single motion.

The features and advantages of the subject matter here will become more apparent in light of the following detailed description of selected embodiments, as illustrated in the accompanying figures. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the figures and examples are not meant to limit the scope of the present subject matter to a single embodiment, but other embodiments are possible by way of interchange of some or all of the described or illustrated elements. For a fuller understanding of the nature of the present invention, reference should be had to the following detailed description and preferred embodiment taken in connection with the accompanying drawing in which:

FIG. 1A is a front view of a greeting card in a closed position, according to an illustrative embodiment;

FIG. 1B is a front view of the greeting card in an open position, with a kinetic mobile sculpture placed therein, according to an illustrative embodiment;

FIG. 1C is a front view of the greeting card, in the open position, with the kinetic mobile sculpture having been removed, according to an illustrative embodiment;

FIG. 1D is a perspective view of the kinetic mobile sculpture in a deployed state, according to an illustrative embodiment;

FIG. 1E is a front view of the greeting card partially removed from an envelope, according to an illustrative embodiment;

FIG. 1F is a cross section view of the greeting card of FIG. 1B, taken along cross section line 1F-1F of FIG. 1B and with the top flap in a closed position, according to an illustrative embodiment;

FIG. 1G is a cross section view of the greeting card of FIG. 1C, taken along cross section line 1F-1F of FIG. 1C, showing the empty pockets after the mobile sculpture has been removed, according to an illustrative embodiment;

FIG. 2A is a front view of a greeting card, in the open position, with a kinetic mobile sculpture placed therein, according to an illustrative embodiment;

FIG. 2B is a front view of the greeting card of FIG. 2A, in the open position, with the kinetic mobile sculpture having been removed, according to an illustrative embodiment;

FIG. 2C is a perspective view of the kinetic mobile sculpture of FIG. 2A in a deployed state, according to an illustrative embodiment;

FIG. 3A is a front view of a greeting card, in the open position, with a kinetic mobile sculpture placed therein, according to an illustrative embodiment;

FIG. 3B is a front view of the greeting card of FIG. 3A in the open position, with the kinetic mobile sculpture having been removed, according to an illustrative embodiment;

FIG. 3C is a perspective view of the kinetic mobile sculpture of FIG. 3A in a deployed state, according to an illustrative embodiment;

FIG. 3D is a perspective view of a kinetic mobile sculpture displayed on a stand, according to an illustrative embodiment;

FIG. 3E is a perspective view of a kinetic mobile sculpture being worn by a user, according to an illustrative embodiment;

FIG. 4A is a front view of a greeting card, in the open position, with a kinetic mobile sculpture placed therein, according to an illustrative embodiment;

FIG. 4B is a front view of the greeting card of FIG. 4A, in the open position, with the kinetic mobile sculpture having been removed, according to an illustrative embodiment;

FIG. 4C is a perspective view of the kinetic mobile sculpture of FIG. 4A in a deployed state, according to an illustrative embodiment;

FIG. 4D is a bottom view of the kinetic mobile sculpture of FIG. 4C in the deployed state, showing structures suspended from within the spiral, according to an illustrative embodiment;

FIG. 5A is a front view of a greeting card, in the open position, with a kinetic mobile sculpture placed therein, according to an illustrative embodiment;

FIG. 5B is a front view of the greeting card of FIG. 5A, in the open position, with the kinetic mobile sculpture having been removed, according to an illustrative embodiment;

FIG. 5C is a perspective view of the kinetic mobile sculpture of FIG. 5A in a deployed state, according to an illustrative embodiment;

FIG. 5D is a bottom view of the kinetic mobile sculpture of FIG. 5C in the deployed state, showing structures suspended from within the spiral, according to an illustrative embodiment;

FIG. 6A is a front view of a greeting card, in the open position, with a kinetic mobile sculpture placed therein, according to an illustrative embodiment;

FIG. 6B is a front view of the greeting card of FIG. 6A, in the open position, with the kinetic mobile sculpture having been removed, according to an illustrative embodiment;

FIG. 6C is a perspective view of the kinetic mobile sculpture of FIG. 6A in a deployed state, according to an illustrative embodiment;

FIG. 7 is a chart showing a method of assembling a greeting card with a kinetic mobile sculpture, according to an illustrative embodiment; and

FIG. 8 is a chart showing a method of deploying the kinetic mobile sculpture, according to an illustrative embodiment.

Other features of embodiments of the present disclosure will be apparent from accompanying drawings and detailed description that follows.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details.

The terms “connected” or “coupled” or “attached” and related or similar terms are used in an operational sense and are not necessarily limited to a direct connection or coupling. Thus, for example, two components or structures may be coupled directly, or via one or more intermediary components or structures. Based on the disclosure provided herein, one of ordinary skill in the art will appreciate a variety of ways in which attachment or coupling exists in accordance with the aforementioned definition.

If the specification states a component or feature “may”, “can”, “could”, or “might” be included or have a characteristic, that particular component or feature is not required to be included or have the characteristic.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily refer to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Thus, it will be appreciated by those of ordinary skill in the art that the diagrams, schematics, illustrations, and the like represent conceptual views embodying this disclosure for example purposes. Those of ordinary skill in the art would further understand that the exemplary diagrams or drawings described herein are for illustrative purposes and, thus, are not intended to be limited to any particular named.

A preassembled kinetic mobile sculpture can have two or more sculpture sections connected together using various connectors. Connectors can include strings, jump rings, hooks, loops, springs, rods, or various other connectors. A preassembled kinetic mobile sculpture can be held, suspended from a ceiling, or otherwise displayed so that the sculpture sections are free to rotate or otherwise move relative to each other.

Embodiments of the present disclosure relate to a greeting card having a holding board with pockets that are adapted to house specific sculpture sections within the pockets. Further, the holding board can house one or more connectors attached to the one or more sculpture sections such that, upon removing from the holding board, one or more sculpture sections can hang from the one or more connectors to create a removable 3-dimensional kinetic mobile sculpture. Further, the greeting card includes a flap for covering the holding board in a closed position, such that, in the closed position, the one or more structures are securely placed and hidden in the pockets of the holding board.

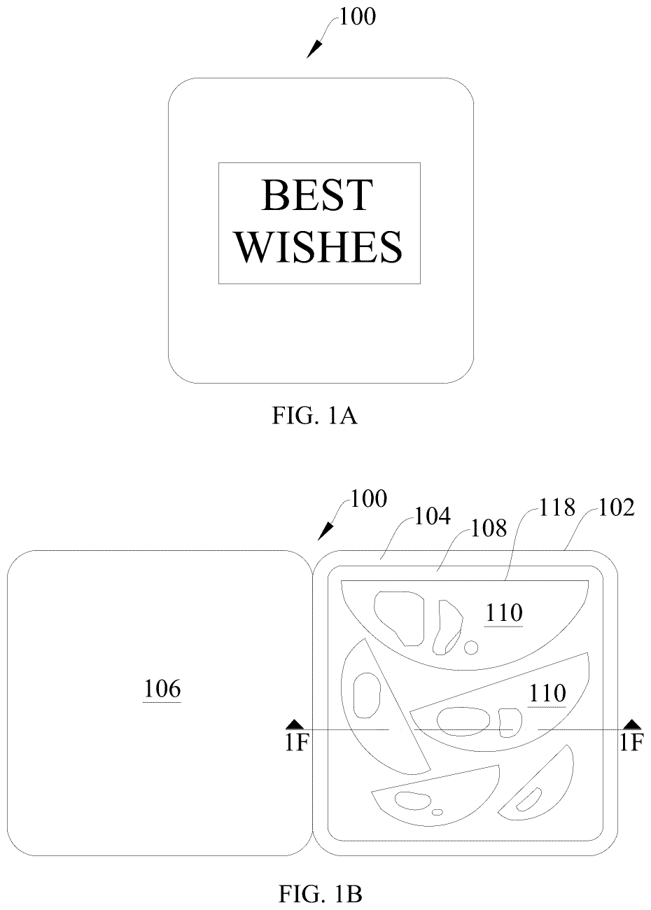

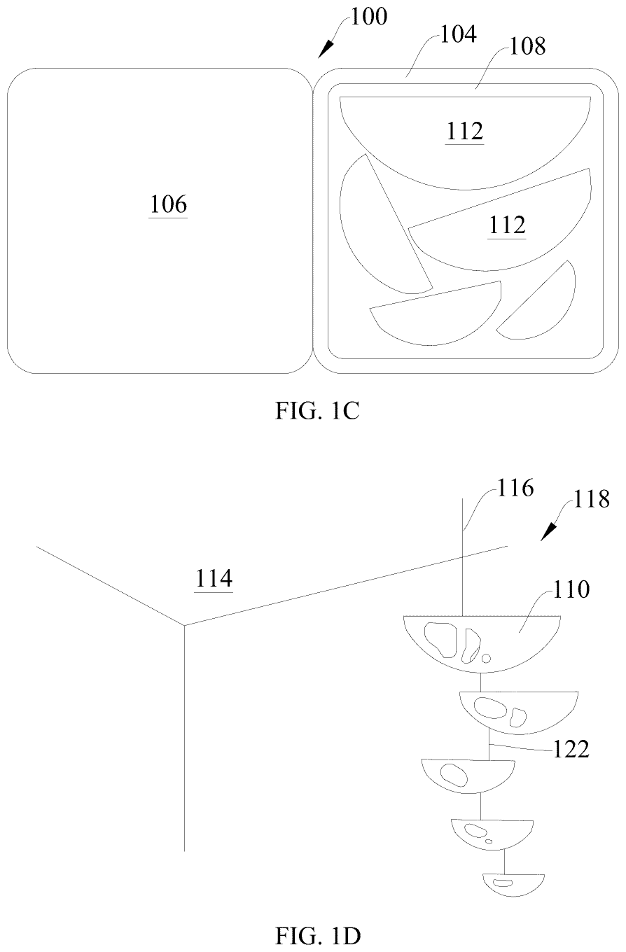

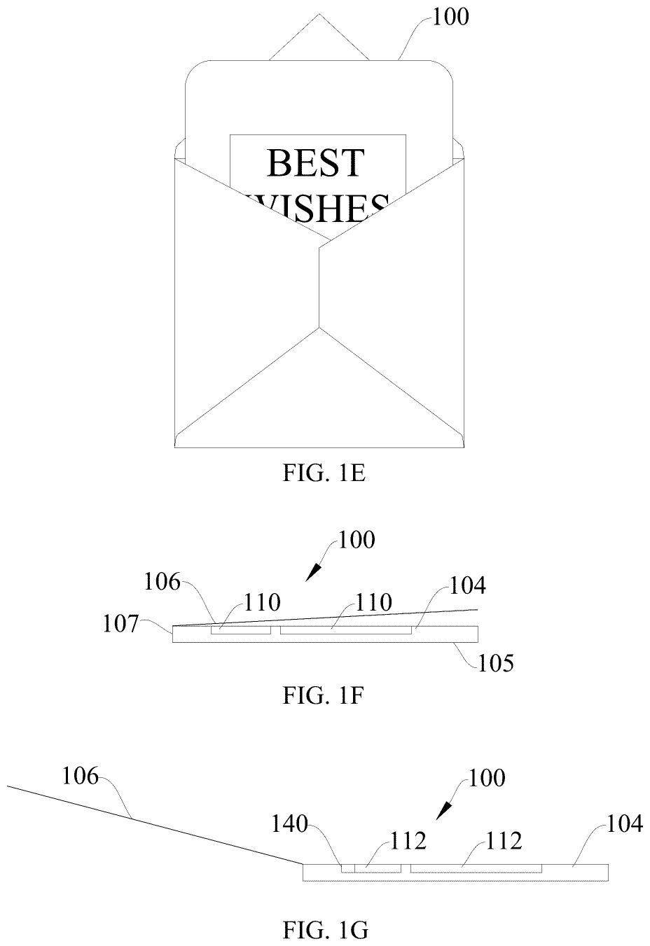

FIG. 1A is a front view of a greeting card 100 in a closed position, according to an illustrative embodiment. FIG. 1B is a front view of the greeting card 100 in an open position, with a kinetic mobile sculpture 118 placed therein, according to an illustrative embodiment. FIG. 1C is a front view of the greeting card 100, in the open position, with the kinetic mobile sculpture having been removed, according to an illustrative embodiment. FIG. 1D is a perspective view of the kinetic mobile sculpture 118 in a deployed state, according to an illustrative embodiment. For the sake of brevity, FIGS. 1A, 1B, 1C, and 1D have been explained together.

In an embodiment, as shown in FIG. 1A, the greeting card 100 may include a front face with a space for customization, such as by way of adding text, pictures, images, or a combination thereof. It may be apparent to a person skilled in the art that the customization may be associated with an occasion (such as birthday, anniversary, Christmas, or the like), a sender (such as sender's picture, sender's name, and/or sender's address), a receiver (such as receiver's name, receiver's name, and/or receiver's address), generic greetings (such as best wishes), or any other event (such as congratulations for new job).

In an embodiment, the greeting card 100 may include a holding board 104 and a flap 106. Either or both of the holding board 104 and the flap 106 may be made of a rigid or semi rigid material such as wood veneer, metal, alloy, plastic, cardboard, packing foam, or a combination thereof. The flap 106 may cover the holding board 104 in a closed position, as shown in FIG. 1A, and may be moved in an open position, as shown in FIG. 1B and 1C, to access the holding board 104.

In an embodiment, the holding board 104 may be made of a material selected from, by way of non-limiting example, foam, wood veneer, cardboard, and/or corrugated board. The holding board 104 may include one or more pockets 112 to house one or more structures. Structures can include various types of sculpture sections 110, including ornamental hanging sections, supports for suspending hanging sections, or other parts of the kinetic mobile sculpture. The one or more structures may be made of a rigid material selected from, by way of non-limiting example, wood veneer, metal, alloy, plastic, cardboard, or a combination thereof. In an embodiment, the holding board 104 may be laser cut, or cut by various other techniques, to form the one or more pockets 112 to house each of the one or more structures such as sculpture sections 110 in fixed locations. An individual pocket can be designed to hold an individual structure, with each structure having its own pocket sized and shaped for that structure.

In various embodiments, a holding board 104 can include an outer rim 102 and a core insert 108. The core insert can be made of a material selected from, by way of non-limiting example, foam, wood veneer, cardboard, and/or corrugated board. The core insert 108 may have the one or more pockets 112 to house one or more structures. The core insert 108 of the holding board 104 can be cut to form the one or more pockets 112, and the core insert 108 can be placed within the outer rim 102 of the holding board 104. In embodiments with an outer rim and a core insert, various core inserts can have pockets adapted to hold different sculptures, and different core inserts can be inserted into the holding rims of different cards. In this way, a modular system can allow for various combinations of different sculptures in different greeting cards with different messages. In other embodiments, a holding board 104 can be a single component with the pockets 112 cut into the holding board.

Further, the holding board 104 can house one or more strings 116 attached to the one or more structures 110, explained more fully below. In various embodiments, the fixed location for the pockets 112 that house each of the one or more structures may be selected in a way that the one or more structures do not tangle with each other. In various embodiments, the fixed location of the pockets 112 for housing each of the one or more structures such as sculpture sections 110 may be selected in a way that the one or more structures are arranged aesthetically to look beautiful.

A complete kinetic mobile sculpture 118 can be stored in a fully assembled state within the pockets 112 in the holding board 104. Each structure can be housed within a custom-shaped pocket 112. Each of the structures can have one or more connectors 122 connecting the structures to neighbouring structures that can be housed within neighbouring pockets. The pockets can be arranged in the housing board so that connected structures are located adjacent to each other, within adjacent pockets. The pockets can be custom sized and shaped to hold each of the various structures. Because the pockets are sized and shaped for each structure, the entire mobile kinetic structure can be secured in a fixed arrangement in the holding board that can be aesthetically pleasing while also being displayed in the card in a way that prevents tangling of the various structures and/or connectors.

A string 116 or other suspender can come pre-attached to an uppermost sculpture section while in the holding board. A string 116 can be attached to the top structure so that the entire kinetic mobile sculpture can be quickly and easily deployed by grasping the string 116 and lifting the entire kinetic mobile sculpture out of the card in one motion. The string can have its own pocket on the holding board, or can be stored on the front of the holding board or can be wrapped around the card and stored on the back of the card. In various embodiments, the string can be stored, for example, in a coiled loop that can be taped to the front of the holding board or back of the card.

FIG. 1E is a front view of the greeting card partially removed from an envelope, according to an illustrative embodiment. The envelope 130 can be sized and shaped to accommodate the greeting card 100. The greeting card can be held securely within the envelope, and the envelope can help to hold the greeting card in the closed position. The envelope can hold the front flap in place over the holding board, thereby holding the kinetic mobile structure in place within the card. By holding the front flap in the closed position, the kinetic mobile structure is held in place with each sculpture section held securely within its respective pocket.

FIG. 1F is a cross section view of the greeting card of FIG. 1B, taken along cross section line 1F-1F of FIG. 1B and with the top flap in a closed position, according to an illustrative embodiment. The holding board 104 can be mounted to the back section 105 of the card 100. The flap 106 can be pivotably connected to the back section 105 of the card. The front flap 106 and the back section 105 can be joined along a common edge 107 between the flap 106 and the back section 105, so that flap 106 can pivot at the common edge 107 relative to the back of the card 105 and the holding board 104.

Each sculpture section 110 is nested within a pocket 112, and each pocket 112 is accommodating a single sculpture section 110. The pockets 112 have a shape, width, depth, etc. to securely hold the sculpture section 110 in place so that the sculpture section 110 does not move or get tangled with other sculpture sections. The holding board 104 can have a thickness designed to accommodate the thickness of the sculpture sections 110 of the preassembled kinetic mobile sculpture 118. As shown, the top flap 106 is covering the holding board 104, so that the top flap 106 can hold the sculpture sections 110 in place and prevent them from falling out of the pocket 112, regardless of the orientation of the greeting card 100 during shipping.

FIG. 1G is a cross section view of the greeting card of FIG. 1C, taken along cross section line 1F-1F of FIG. 1C, showing the empty pockets 112 after the mobile sculpture has been removed, according to an illustrative embodiment. Each pocket has sidewalls 140 that can brace the sculpture sections in place. Each pocket can have a pocket depth that is deep enough to accommodate a sculpture section within the pocket, so that the flap can close over the sculpture sections and rest in contact with the holding board, as shown in FIG. 1F.

In the closed position, the one or more structures may be securely placed and hidden in the pockets 112 of the holding board 104 by the flap 106. The user can open the flap 106 to view, access, and/or remove the kinetic mobile sculpture 118 from the holding board 104. The removable 3-dimensional kinetic mobile sculpture 118 is pre-assembled and a user may hold the string 116 to remove the one or more structures for immediate deployment.

Upon removing from the holding board 104, the one or more structures may hang from the string 116 to represent a removable 3-dimensional kinetic mobile sculpture 118, as shown in FIG. 1D. In an illustrated embodiment, the 3-dimensional kinetic mobile sculpture 118 may be a hangable decorative that can be removably attached to a ceiling 114. It may be apparent to a person skilled in the art that the hangable decorative may be attached to the ceiling 114 via one or more ways and structures known in the art without departing from the scope of the disclosure.

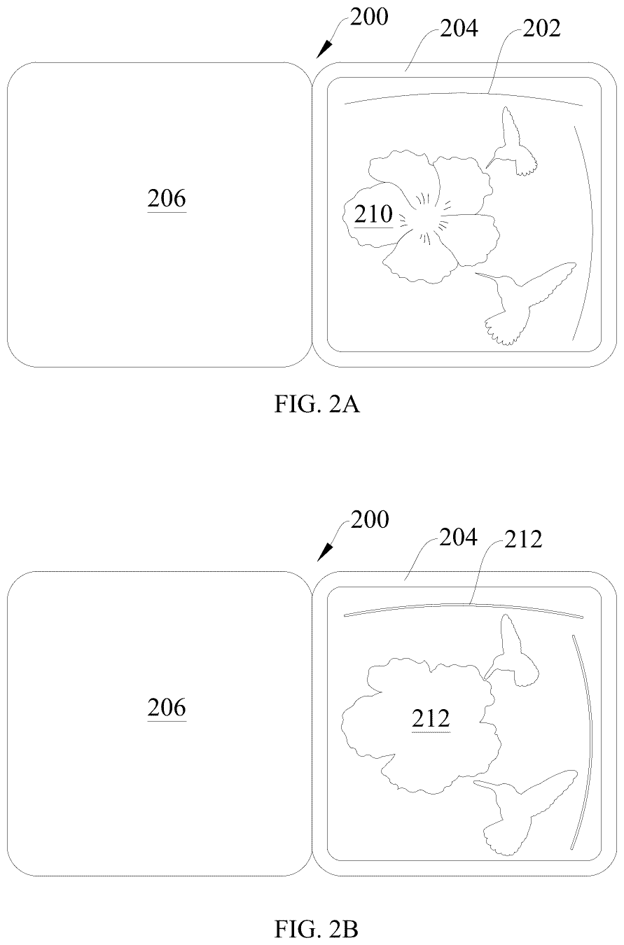

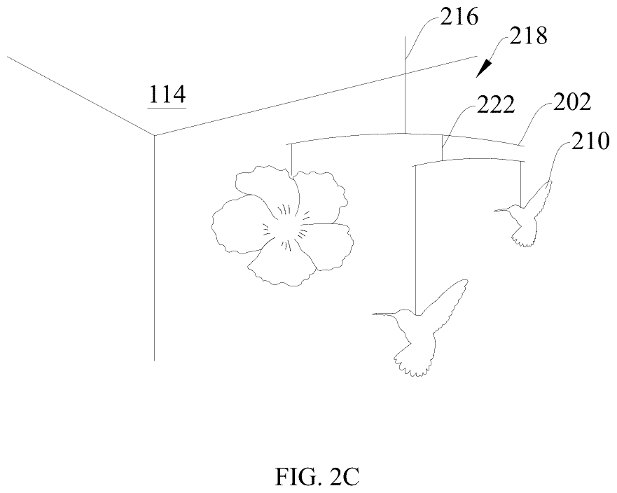

FIG. 2A is a front view of a greeting card 200, in the open position, with a kinetic mobile sculpture 218 placed therein, according to an illustrative embodiment. FIG. 2B is a front view of the greeting card 200 of FIG. 2A, in the open position, with the kinetic mobile sculpture 218 having been removed, according to an illustrative embodiment. FIG. 2C is a perspective view of the kinetic mobile sculpture 218 of FIG. 2A in a deployed state, according to an illustrative embodiment. For the sake of brevity, FIGS. 2A, 2B, and 2C have been explained together.

In an embodiment, the 3-dimensional kinetic mobile sculpture 218 may include various structures including one or more couplers 202 and one or more sculpture sections 210. In various embodiments, a coupler 202 can be a bar that can support various sculpture sections at various positions along the bar. Connectors 222 can be used to connect structures such as couplers and sculpture sections to other structures such as couplers and sculpture sections. A string 216 can be used to deploy the kinetic mobile sculpture and removably attach the kinetic mobile sculpture 218 to the ceiling 114. As illustrated, the coupler(s) 202 may also be housed in the core inset 204 in a corresponding pocket(s) 112. In an embodiment, as shown in FIG. 2C, a string 216 may be utilized to hang the 3-dimensional kinetic module sculpture 218 from the ceiling 114. In various embodiments, a structure such as a coupler 202 may use an adhesive, a hook or other means for for directly attaching the 3-dimensional mobile sculpture 218 to the ceiling 114, another surface convenient to a user, the body of the user, or others.

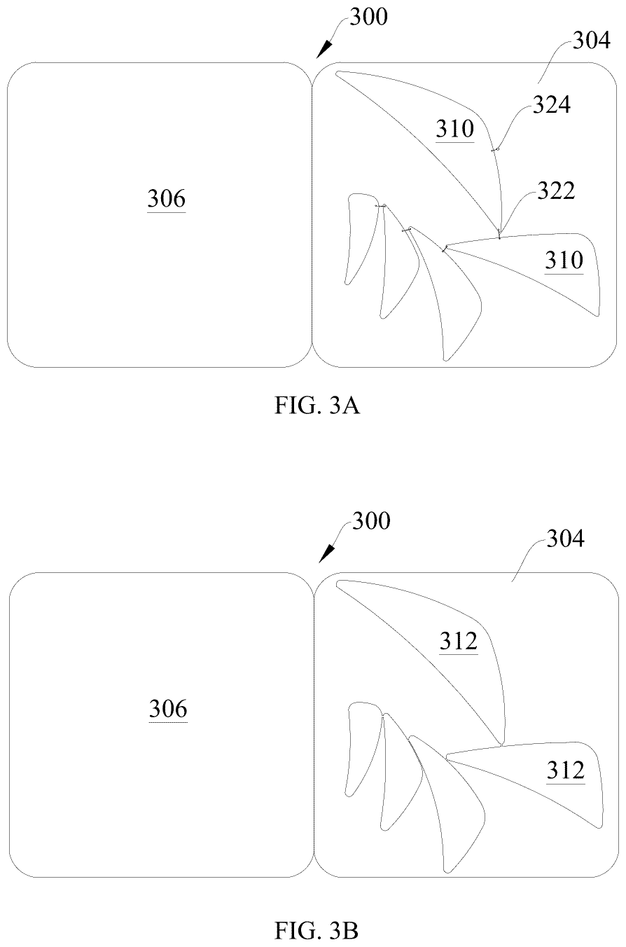

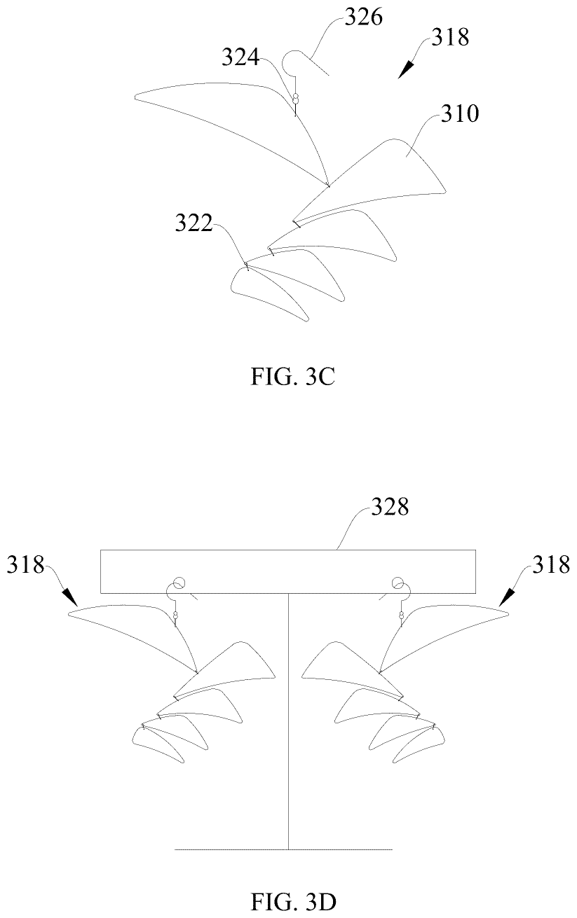

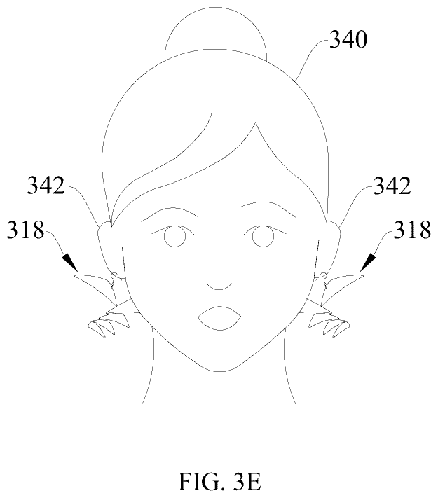

FIG. 3A is a front view of a greeting card 300, in the open position, with a kinetic mobile sculpture 318 placed therein, according to an illustrative embodiment. FIG. 3B is a front view of the greeting card 300 of FIG. 3A in the open position, with the kinetic mobile sculpture 318 having been removed, according to an illustrative embodiment. FIG. 3C is a perspective view of the kinetic mobile sculpture 318 of FIG. 3A in a deployed state, according to an illustrative embodiment. FIG. 3D is a perspective view of a kinetic mobile sculpture 318 displayed on a stand, according to an illustrative embodiment. FIG. 3E is a perspective view of a kinetic mobile sculpture 318 being worn by a user 340, according to an illustrative embodiment. For the sake of brevity, FIGS. 3A, 3B, 3C, 3D, and 3E have been explained together.

In various embodiments, the holding board 304 may not have a separate outer rim and core insert. The holding board 304 can include one or more pockets 312 to house the one or more structures such as sculpture sections 310. The one or more structures may be movably connected to one or more other structures via connectors 322. By way of example, the one or more connectors 322 may, without limitation, include jump rings, strings, springs, or a combination thereof. Further, at least one of the one or more structures such as sculpture sections 310 may also include (or have an attached) a deployer 324 such as a loop or hook that can be used for easy deployment. A deployer 324 can be connected directly to a string, hanging hook, earing, or others. A holding board 304 can have pockets 312 that includes spaces for connectors, deployers, hooks, etc. Each component of a kinetic mobile sculpture can fit within a corresponding pocket. Various pockets and/or connections between pockets can be adapted to hold the components of the kinetic sculpture, as shown in FIG. 3B.

In various embodiments, such as shown in FIGS. 3C, 3D, and 3E, the kinetic mobile sculpture 318 may be an earring having a hook 326 to removably attach the kinetic mobile sculpture 318 to a stand 328 and/or an ear 342 of a user 340, as shown in FIGS. 3D and 3E respectively. Accordingly, the hook 326 may, by way of non-limiting example, include earring hook, earring post, earring stud, earring back and clutch, earring hoop, lever back, threader, fingernail, and/or clip.

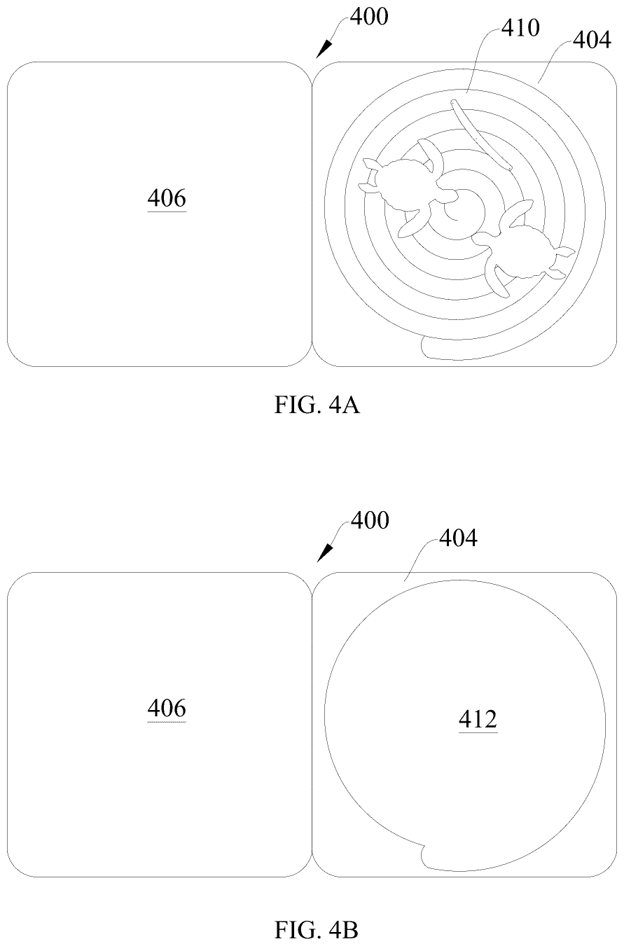

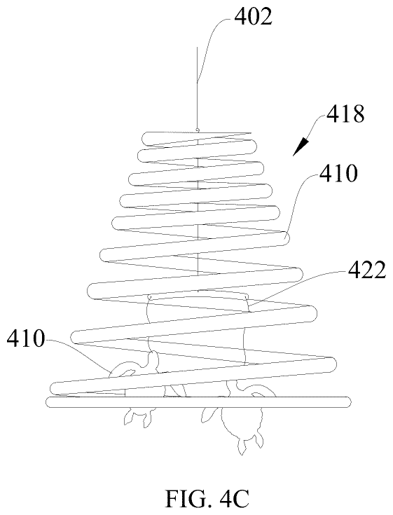

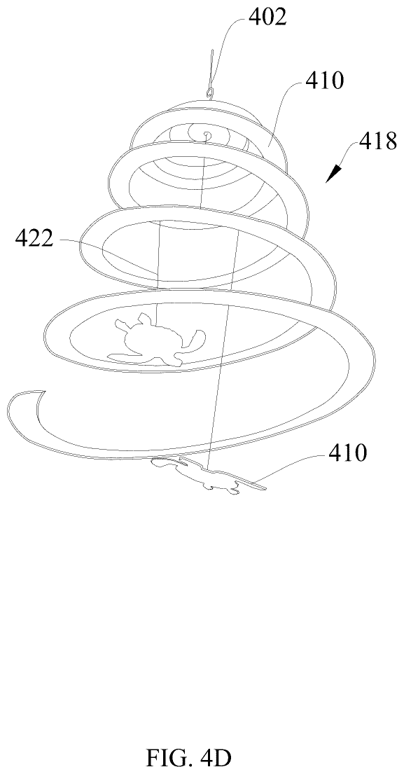

FIG. 4A is a front view of a greeting card 400, in the open position, with a kinetic mobile sculpture 418 placed therein, according to an illustrative embodiment. FIG. 4B is a front view of the greeting card 400 of FIG. 4A, in the open position, with the kinetic mobile sculpture having been removed, according to an illustrative embodiment. FIG. 4C is a perspective view of the kinetic mobile sculpture 418 of FIG. 4A in a deployed state, according to an illustrative embodiment. FIG. 4D is a bottom view of the kinetic mobile sculpture of FIG. 4C in the deployed state, showing structures 410 suspended from within the spiral, according to an illustrative embodiment. For the sake of brevity, the FIGS. 4A, 4B, 4C, and 4D have been explained together.

In an embodiment, the kinetic mobile structure 418 may be a spiral lampshade design. In such a scenario, at least one of the one or more sculpture sections 410 may be a conical helix, or other shape that can be deployed to form a three-dimensional backdrop for displaying themed sculpture sections 410. The three-dimensional backdrop can be a shape such as a spiral that can be stored in a flat conformation within the holding board, and can be deployed to form a three dimensional shape such as a conical helix. However, it should be clear that various shapes are possible, including, by way of non-limiting example, triangular or square spirals.

In various embodiments, such as shown in FIGS. 4A and 4B, the pockets 112 can have a pocket depth that is deep enough to accommodate the multiple sculpture sections stacked on top of each other. In various embodiments, the pockets can have a pocket depth that is designed to accommodate the thickness of two sculpture sections, so that themed sections can be displayed on top of a backdrop section, such as the turtle sections displayed on top of the helical spiral section as shown in FIG. 4A. The pocket can be a single pocket sized and shaped to securely hold a backdrop section, and themed sections can be displayed in the same pocket, over the background section.

At least one of the one or more structures may represent a theme. For example, the greeting card 400 may be for a turtle lover and at least one of the one or more structures 410 may represent one or more turtles. In an embodiment, the one or more structures 410 may be attached to a coupler 402 via one or more connectors 422, such that, upon removal from the holding board 404, the kinetic mobile sculpture 418, includes a three-dimensional backdrop for displaying the themed structures, and at least one of the one or more sculpture sections can be aesthetically placed around an outer surface of the three dimensional backdrop, or can be aesthetically suspended from within the three dimensional backdrop as shown in FIGS. 4C and 4D. It may be apparent to a person skilled in the art to add other aesthetics to the one or more structures, such as images of fishes on the conical helix in a way that during deployment it appears in a 3-dimensional image.

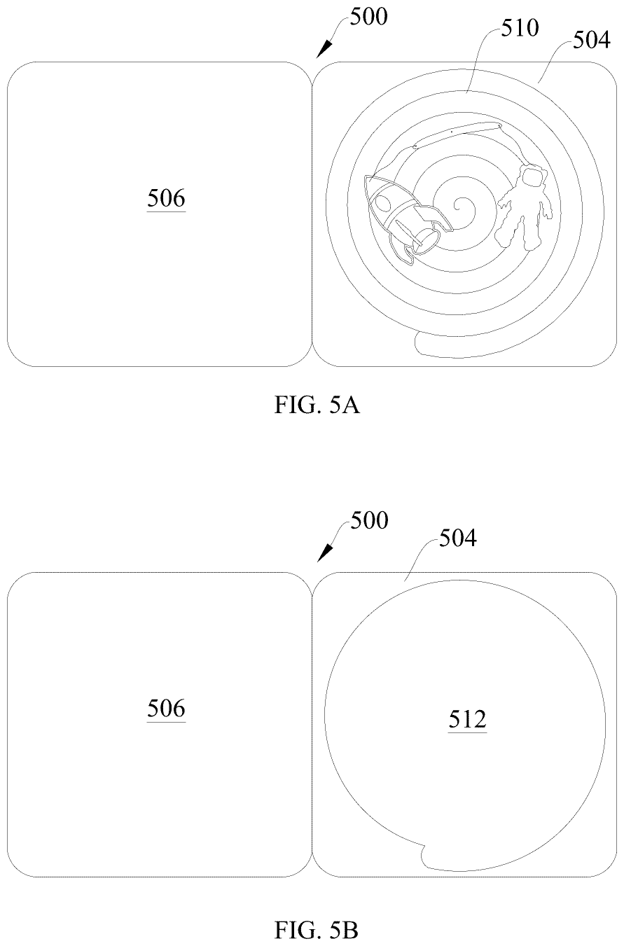

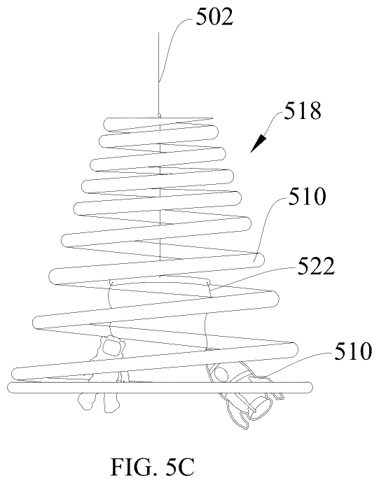

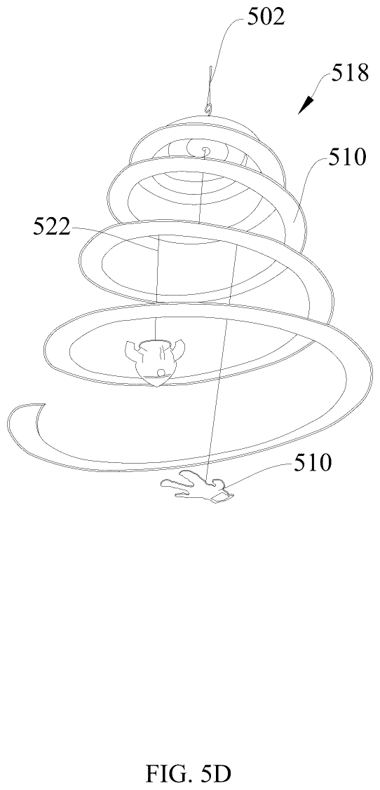

FIG. 5A is a front view of a greeting card 500, in the open position, with a kinetic mobile sculpture 518 placed therein, according to an illustrative embodiment. FIG. 5B is a front view of the greeting card 500 of FIG. 5A, in the open position, with the kinetic mobile sculpture 518 having been removed, according to an illustrative embodiment. FIG. 5C is a perspective view of the kinetic mobile sculpture 518 of FIG. 5A in a deployed state, according to an illustrative embodiment. FIG. 5D is a bottom view of the kinetic mobile sculpture of FIG. 5C in the deployed state, showing structures 510 suspended from within the spiral, according to an illustrative embodiment. For the sake of brevity, FIGS. 5A, 5B, and 5C have been explained together.

In an embodiment, the greeting card 500 may, for example, be for an outer space lover and the corresponding kinetic mobile structure 518 may have a design that includes a three-dimensional backdrop for displaying space-themed sculpture sections 510. In such a scenario, at least one of the one or more structures may be a conical helix, or other shape that can be deployed to form a three-dimensional backdrop for displaying the themed sculpture sections 510. In various embodiments, at least one of the one or more sculpture sections 510 may represent, by way of non-limiting example, a rocket and/or an astronaut.

In various embodiments, a string or hook (not shown) may be connected to the coupler 502, and the user can grasp the string or hook to pull the kinetic mobile sculpture out of the greeting card for deployment. In various embodiments, the user may hold the coupler 502 to deploy the kinetic mobile sculpture from the greeting card. A coupler 502 can be attached to one or more sculpture sections 510 via one or more connectors 522. Upon deployment, the kinetic mobile structure 518 can form a three-dimensional backdrop, such as a helical cone, and at least one of the one or more sculpture sections 510 can be aesthetically displayed around an outer surface of the three-dimensional backdrop, or can be aesthetically suspended from within the three dimensional backdrop as shown in FIGS. 5C and 5D. It may be apparent to a person skilled in the art to add other aesthetics to the one or more structures, such as clouds on the conical helix in a way that during deployment it appears in a 3-dimensional cloud.

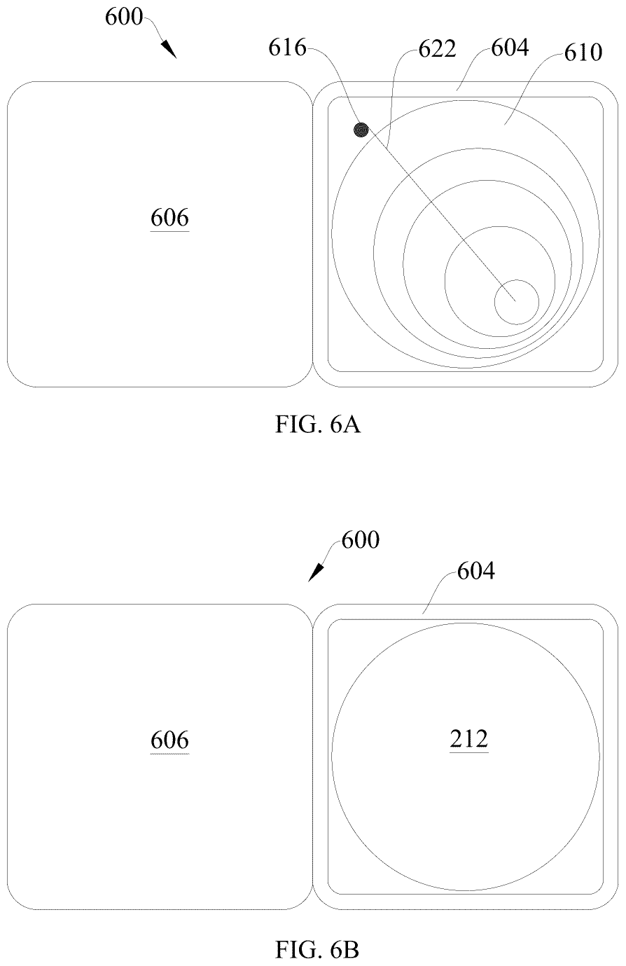

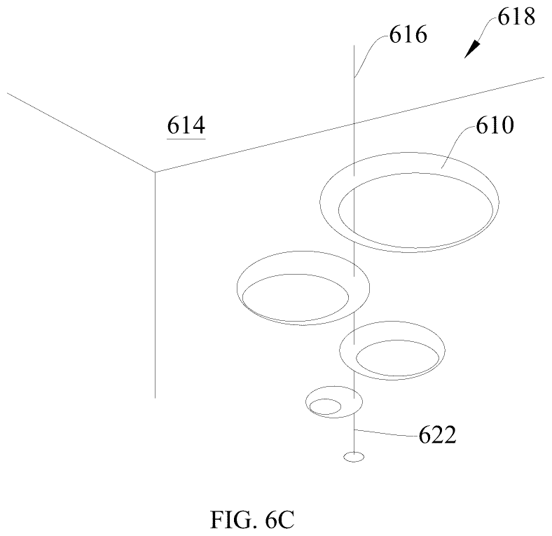

FIG. 6A is a front view of a greeting card 600, in the open position, with a kinetic mobile sculpture placed therein, according to an illustrative embodiment. FIG. 6B is a front view of the greeting card 600 of FIG. 6A, in the open position, with the kinetic mobile sculpture having been removed, according to an illustrative embodiment. FIG. 6C is a perspective view of the kinetic mobile sculpture 618 of FIG. 6A in a deployed state, according to an illustrative embodiment. For the sake of brevity, FIGS. 6A, 6B, and 6C have been explained together.

In various embodiments, the kinetic mobile structure 618 may be a design with concentric rings or other concentric shapes. In such a scenario, at least one of the one or more sculpture section 610 may be a closed ring, and a series of closed rings can be suspended to form at least part of the kinetic mobile structure. Although the sculpture sections 610 are shown and described as being approximately ring shaped, it should be clear that various concentric shapes are possible.

The holding board 604 may include one or more pockets 612 to house the one or more structures such as sculpture sections 610. Each component of a kinetic mobile sculpture can fit within a corresponding pocket, and in various embodiments, multiple sculpture sections can fit within the same pocket. The one or more structures may be movable connected to one or more other structures via connectors 622. By way of example, the one or more connectors 622 may, without limitation, include jump rings, strings, springs, or a combination thereof. A string 616 can be used to deploy the kinetic mobile structure and removably attach the kinetic mobile structure 618 to the ceiling 114. In various embodiments, the connectors 622 may be part of the string 616. In such an embodiment, the sculpture sections may hang approximately in a line, with one below the next. In various embodiments, the connectors 622 may include separate components from the string 616, so that sculpture sections may optionally not hang in the same line.

It may be apparent to a person skilled in the art that the one or more parts of the greeting card such as the holding board, the flap, the one or more structures, and the one or more pockets may be colored (such as using one or more colors), designed (such as tapered cutting), or modified (such as adding graphics or glitters) for customized aesthetics without departing from the scope of the present disclosure.

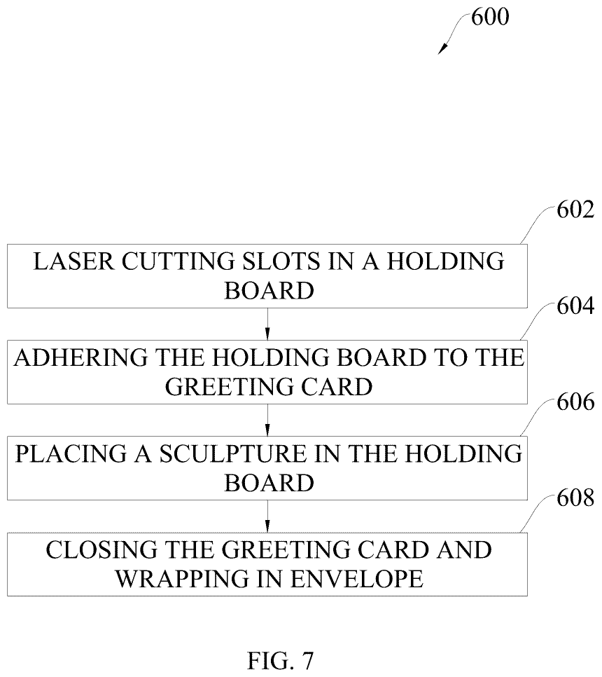

FIG. 7 is a chart showing a method 700 of assembling a greeting card with a kinetic mobile sculpture, according to an illustrative embodiment. At box 702, a holding board can be designed to accommodate the structures of a preassembled kinetic mobile sculpture. The holding board can be made of various materials such as foam, wood veneer, cardboard, or corrugated board. In various embodiments, laser cutting technology can be used to create precise pockets in the holding board. The pockets can be strategically designed to securely accommodate the various structures of a preassembled sculpture. The shape and size of the pockets can be carefully matched to the corresponding components of the sculpture to ensure that the components fit perfectly without damage or tangling.

At box 704, the holding board, with the laser-cut pockets, can be adhered or attached to the back section of the greeting card. The holding board can be attached to the interior of the card, making the holding board hidden from view when the card is in the closed or folded position.

At box 706, the kinetic mobile sculpture can be placed within the laser-cut pockets of the holding board. The sculpture sections can fit snugly into corresponding designated pockets so that there is no risk of falling out or getting damaged during shipping or handling.

At box 708, the front flap can be closed over the holding board to transition the greeting card from the open position to the closed or position, and can be placed in an envelope for shipping. In the closed position, the envelope can hold the front flap in place over the holding board, so that the sculpture sections are held in place within the pockets and are secured for shipping.

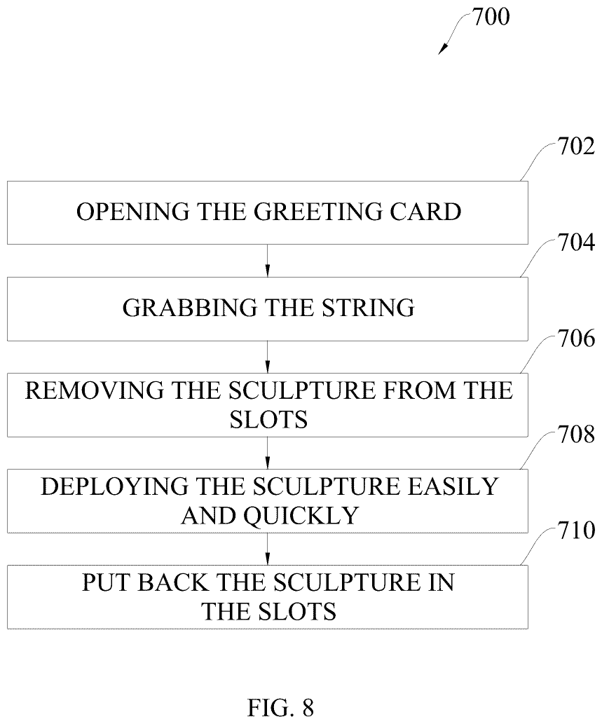

FIG. 8 is a chart showing a method of deploying the kinetic mobile sculpture, according to an illustrative embodiment. At box 802, the user can remove the card from an envelope and open the front flap. The preassembled kinetic mobile sculpture will be revealed within the holding board.

At box 804, the user can grasp the string or other suspender attached to the topmost sculpture structure. At box 806, the user can pull the string or other suspender to lift the entire preassembled kinetic mobile sculpture out of the holding board in one motion.

At box 808, the user can deploy the preassembled kinetic mobile sculpture without the need for assembly or detangling (free of assembly and detangling). Lifting the preassembled kinetic mobile sculpture out of the holding board allows the sculpture to take it's intended shape without further effort or intervention from the user.

In an optional step 810, the user can reverse the process by placing the structures such as sculpture sections back into the pockets of the greeting card for storage.

The greeting card with preassembled sculpture described herein of can combine the traditional concept of a greeting card with a hidden, preassembled sculpture. The card can be customized for different occasions, events, and seasons. The laser-cut pockets in the holding board can securely hold the sculpture, preventing damage or tangling. The slots are designed to match the sculpture's shape and size, ensuring a snug fit.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications (at least in terms of aesthetics and size) besides those already described are possible without departing from the inventive concepts herein. While the foregoing describes various embodiments of the disclosure, other and further embodiments of the disclosure may be devised without departing from the basic scope thereof. The disclosure is not limited to the described embodiments, versions, or examples, which are included to enable a person having ordinary skill in the art to make and use the disclosure when combined with information and knowledge available to the person having ordinary skill in the art.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed is:

1. A greeting card comprising:
a kinetic mobile sculpture comprising:
a plurality of structures movably attached together via one or more connectors; and
a suspender attached to one of the plurality of structures such that, upon removing from the holding board, the plurality of structures hang from the suspender to represent a removable 3-dimensional kinetic mobile; and
a holding board having a plurality of pockets, the pockets corresponding to the plurality of structures and adapted to hold the structures within the pockets.

2. The greeting card of claim 1, further comprising a flap for covering the holding board in a closed position, such that, in the closed position, the one or more structures are securely placed and hidden in the pockets of the holding board.

3. The greeting card of claim 1, wherein the holding board is laser cut to house each of the one or more structures in fixed locations.

4. The greeting card of claim 3, wherein the fixed location for housing each of the plurality of structures is selected in a way that the one or more structures do not tangle with each other as the structures are removed from the holding board.

5. The greeting card of claim 3, wherein the fixed location for housing each of the plurality of structures is selected in a way that the plurality of structures are placed aesthetically to look beautiful when the flap is removed.

6. The greeting card of claim 3, wherein the holding board is made of a material selected from at least one of: foam, wood veneer, cardboard, and corrugated board.

7. The greeting card of claim 1, wherein the one or more structures are made of a rigid material selected from at least one of: wood veneer, metal, alloy, plastic, and cardboard.

8. The greeting card of claim 1, wherein the kinetic mobile sculpture is a hangable decorative, and the suspender is attached to a first coupler so that the kinetic mobile sculpture can be removably attached to a ceiling by the suspender.

9. The greeting card of claim 1, wherein the kinetic mobile sculpture is an earring, and the kinetic mobile sculpture stored within the holding board includes a hook adapted to removably attaching the kinetic mobile sculpture to an ear.

10. The greeting card of claim 1, wherein the kinetic mobile sculpture further comprises a three-dimensional backdrop, wherein the three dimensional backdrop is stored in a flat conformation within the holding board and is adapted to be deployed automatically into a three-dimensional conformation when the three- dimensional backdrop is removed from the holding board, without further assembly by the user.

11. The greeting card of claim 10, wherein at least one of the plurality of structures are aesthetically arranged around an outer surface of the three-dimensional backdrop.

12. The greeting card of claim 1, wherein the holding board is made of a rigid material selected from at least one of: wood veneer, metal, alloy, plastic, and cardboard.

13. The greeting card of claim 1, wherein the one or more connectors include at least one of: jump ring, string, and spring.

14. The greeting card of claim 1, wherein the removable 3-dimensional kinetic mobile sculpture is pre-assembled while packaged in the holding board, and the 3-dimensional kinetic mobile sculpture is adapted for a user to lift the suspender to remove the kinetic mobile sculpture for immediate deployment.

15. A greeting card comprising:
a front flap;
a back section; and
a holding board secured to the back flap, the holding board having a plurality of pockets, the pockets adapted to correspond to a plurality of structures of a kinetic mobile sculpture and adapted to hold the structures within the pockets;
wherein the front flap is pivotably connected to the back section, and wherein the front flap can be pivoted between an open position and a closed position, and wherein in the closed position the front flap can lay over the holding board and cover the pockets.

16. The greeting card of claim 15, wherein the one or more connectors include at least one of: jump ring, string, and spring.

17. A method of deploying a preassembled kinetic mobile sculpture comprising:
opening a front flap of the greeting card to reveal a holding board, the holding board having a plurality of pockets adapted to correspond to a plurality of structures of a pre-assembled kinetic mobile sculpture, and wherein the plurality of structures of the preassembled kinetic mobile sculpture are housed within the pockets of the holding board;
grasping a string attached to one of the plurality of structures of the preassembled kinetic mobile sculpture;
lifting the preassembled kinetic mobile sculpture out of the holding board of the greeting card; and
displaying the preassembled kinetic mobile sculpture without the need for assembly of the kinetic mobile sculpture.

18. The method of claim 17, wherein lifting the preassembled kinetic mobile sculpture out of the holding board of the greeting card further comprises lifting the preassembled kinetic mobile sculpture out of the holding board of the greeting card in a single motion.
